(19) United States
(12) Patent Application Publication
(10) Pub. No.: US 2026/0151722 A1
(43) Pub. Date: Jun. 4, 2026

(54) PLEAT PACK BLANK

(71) Applicant: CAMFIL USA, INC., Riverdale, NJ (US)

(72) Inventor: Daniel VANGILDER, Jonesboro, AR (US)

(21) Appl. No.: 18/917,079

(22) Filed: Oct. 16, 2024

(51) Int. Cl. B01D 46/52

(52) U.S. Cl. CPC B01D 46/523; B01D 46/522

(57) ABSTRACT

The disclosure relates to a pleat pack blank (1) comprising a pleatable air filter sheet material (2) having first (3) and second (4) opposing sides and including a plurality of first and second transversal folding lines (5,6) positioned in a direction (T) transverse to a longitudinal direction (L) of the sheet material, such that the sheet material can be folded into a pleated zig-zag configuration, where each of said first transversal folding lines (5) forms a first apex (5a) toward said first side (3) of the sheet material, and each of said second transversal folding lines (6) forms a second apex (6a) toward said second side (4) of the sheet material, said pleat pack blank further including a plurality of first spacer elements (7) applied on said first side (3) of the sheet material, and a plurality of second spacer elements (8a,8b) applied on said second side (4) of the sheet material, characterized in that each of said first spacer elements (7) is arranged across the first apex (5a) of a first transversal folding line (5) and extends in the longitudinal direction of the sheet material along a longitudinal line (L1), and each of said second spacer elements (8a,8b) is arranged between the second apex (6a) of a second transversal folding line (6) and a mid-pleat line (T1a, T1b) located half-way between two adjacent first and second transversal folding lines (5,6).

### TECHNICAL FIELD

The present disclosure relates to a pleat pack blank suitable for use in air filters, a pleat pack and an air filter comprising the pleat pack blank.

### BACKGROUND ART

Air filters often include air filter cartridges comprising air filter media, which is typically pleated to make a large surface area for filtration available within a limited space to enhance the filter's capacity to capture and retain particles and other airborne contaminants. Wedge-shaped cross-sections between the pleats on both sides of the pleated filter media contributes to even flow through the filter to allow optimal utilization of the surface area of the filter. To ensure the effective operation of the filter, it is important to maintain the open structure of the pleats. This may be achieved by applying glue beads between the pleats as shown for example in the published patent application US2004/0261376A1. However, there is an ongoing desire to provide improved pleated air filter media packs for use in air filtration.

### SUMMARY

The present disclosure aims at providing an improved pleat pack blank for use in air filters, comprising a pleatable air filter sheet material having first and second opposing sides and including a plurality of first and second transversal folding lines positioned in a direction transverse to a longitudinal direction of the sheet material, such that the sheet material can be folded into a pleated zig-zag configuration, where each of the first transversal folding lines forms an apex toward the first side of the sheet material, and each of the second transversal folding lines forms an apex toward the second side of the sheet material. The pleat pack blank includes a plurality of first spacer elements applied on the first side of the sheet material, and a plurality of second spacer elements applied on the second side of the sheet material. Each of the first spacer elements is arranged across the apex of a first transversal folding line and extends in the longitudinal direction of the sheet material along a longitudinal line, and each of the second spacer elements is arranged between the apex of a second transversal folding line and a mid-pleat line located half-way between two adjacent first and second transversal folding lines. The improved pleat pack blank allows for enhanced air filtration and for a wider range of materials that may be used as the air filter material.

The second spacer elements are arranged on the second side of the air filter sheet material in positions that are suitably transversely displaced in relation to said first spacer elements. The first spacer elements may advantageously be positioned along two or more parallel first longitudinal lines, preferably with a distance between two adjacent first longitudinal lines of 0.5-3.0 inches, more preferably 1.5-2.5 inches. The second spacer elements may advantageously be positioned along two or more parallel second longitudinal lines, preferably with a distance between two adjacent second longitudinal lines of 0.5-3.0 inches, more preferably 1.5-2.5 inches. Advantageously, two adjacent second spacer elements may be arranged on each side of a second transversal folding line on a corresponding distance from second transversal folding line. The first spacer elements may suitably extend in the longitudinal direction to a length on each side of said first transversal folding line corresponding to 20-85% of the distance between a first transversal folding line and a second transversal folding line. The first and second spacer elements may suitably consist of glue beads.

The present disclosure further relates to an air filter pleat pack comprising at least one of the above pleat pack blank, wherein the pleat pack blank has been folded into a pleated zig-zag configuration such that first spacer elements adjacent in the longitudinal direction of the air filter sheet material are in contact with each other. The air filter pleat pack may have the shape of a cuboid or arch, or it may have been joined at the transversal edges of the pleat pack(s) into a hollow pleat pack, so that said first side of the sheet material is facing inward and said second side of the sheet material is facing outward. The hollow pleat pack may have the shape of a cylinder or a cone or pyramid, such as a truncated cone or pyramid.

The present disclosure further relates to an air filter comprising at least one of the above pleat pack, wherein the pleat pack is positioned such that said first side of the air filter sheet material is on an inner side of a hollow pleat pack, which may be the downstream side during air filtration.

The present invention will become apparent from the detailed description given below. The detailed description and specific examples disclose preferred embodiments of the disclosure by way of illustration only. Those skilled in the art understand from guidance in the detailed description that changes and modifications may be made within the scope of the disclosure. Hence, it is to be understood that the herein disclosed disclosure is not limited to the particular component parts of the device described or steps of the methods described since such device and method may vary. It is also to be understood that the terminology used herein is for the purpose of describing particular embodiments only, and is not intended to be limiting.

### BRIEF DESCRIPTIONS OF THE DRAWINGS

FIG. 1 shows a schematic cross-sectional view of an example of a pleat pack blank according to the present disclosure;

FIG. 2 shows a schematic top view of the pleat pack blank of FIG. 1;

FIG. 3 is a schematic cross-sectional view of a portion of a pleat pack of the present disclosure;

FIG. 4 schematically illustrates a prior art pleat pack;

FIG. 5a schematically illustrates an air filter element comprising a cuboid pleat pack;

FIG. 5b is a cross-sectional view of the air filter element of FIG. 5a, along the line A-A;

FIG. 6 schematically illustrates an air filter element comprising a hollow cylindrical pleat pack;

FIG. 7 schematically illustrates an air filter element comprising a hollow conical pleat pack;

FIG. 8a schematically illustrates an example of a cross-section of hollow pleat pack;

FIG. 8b schematically illustrates another example of a cross-section of hollow pleat pack.

FIG. 8c schematically illustrates yet another example of a cross-section of hollow pleat pack.

FIG. 8d schematically illustrates an example of a cross-section of an arched pleat pack part.

### DETAILED DESCRIPTION

The present disclosure relates to a pleat pack blank comprising a pleatable air filter sheet material (air filter media), which is intended to be pleated into a pleat pack and mounted in air filter material receiving frame or the like to form an air filter element. The pleatable air filter sheet material has first and second opposing sides and includes a plurality of first and second transversal folding lines, i.e. pre-formed score lines, positioned in a direction transverse to a longitudinal direction (machine direction) of the sheet material, such that the sheet material can be folded into a pleated zig-zag configuration. The pleating of the air filter sheet material can be made for example in a blade pleater or in a rotary pleater. The pleated configuration is desired since it gives an increased area of air filter material in the final air filter element. The first transversal folding lines forms an apex toward the first side of the sheet material, and each of the second transversal folding lines forms an apex toward the second side of the sheet material. This means that when the pleated blank is placed with the first side of the sheet material upwards, the first transversal folding lines forming apexes will be directed upward, and between each pair of apexes, the second transversal folding lines form the bottom of a valley on the first side of the sheet material, and an apex downward seen from the second side of the sheet material. Rectangular sheet material portions arise in the valley between adjacent apexes on the same side, which form wedge-like channels in the pleat pack with the rectangular portions as the channel walls. In practice, the pleats of a pleat pack will be very close to each other, which means that the height of a wedge like channel will substantially correspond to the distance between two adjacent folding lines. In a typical air filtration application, the first side of the sheet material may be facing the downstream side of the air filter and the second side may be facing the upstream side.

In order to obtain efficient air flow through the air filter, it is important that the shape of the channels is maintained, and in particular that the channel walls are kept substantially flat in operation. However, it has been found that the filter media in the channel walls of hitherto available pleated air filters has a tendency to bulge in operation, as illustrated in FIG. 4, especially when the air filter media is chosen from a sheet material with low rigidity. A pleated filter media may look fine as it leaves the factory and the tendency to bulge isn't noticed until the filter is loaded with dust and the forces/resistance becomes high enough to “bulge” the pleats. This can lead to impaired air flow and to increased risk of dust getting trapped in the wedge-like channels, causing ineffective utilization of the filter media. It is also important to ensure that all pleat channels remain open towards the first side and to avoid that some pleat channels expand, causing adjacent channels to contract or even fold shut, which then prevents use of the media area in the blocked pleats.

The pleat pack blank of the present disclosure includes a plurality of first spacer elements applied on the first side of the sheet material, and a plurality of second spacer elements applied on the second side of the sheet material. By providing spacer elements on both sides of the air filter sheet material, it can be ensured that the channels formed in the pleat pack are kept open and flat, and the risk that that some pleat channels expand, causing adjacent channels to contract or fold shut can be reduced, thus maintain proper air filtration properties and use of filter media. The first spacer elements are arranged across the apex of a first transversal folding line and extend in the longitudinal direction of the sheet material, thus stabilizing the sheet material close to the apex. The second spacer elements are arranged between the apex of a second transversal folding line and a mid-pleat line located half-way between two adjacent first and second transversal folding lines. The first spacer elements extending across the apex of the first transversal folding lines stabilize the sheet material so that the shape of the pleats is maintained. The second spacer elements, not extending over the apex, permit the pleat pack to curve to form the pleat pack into an arc, cylinder or cone. Thus, by having second spacer elements not extending across the apex on the second side of the sheet material, the blank can curve to make a cylinder/cone, which would not have been possible if the spacer elements had extended across the apex on both the first and second sides of the material. The spacer elements are thus placed so that they limit the flexibility of the sheet material (air filter media) in the longitudinal direction. When force is applied to fold the pleat pack blank into a pleat pack, the media is only allowed to fold at the score lines. This creates a flat stiffened pleat by using the structural support of the spacer element rather than relying solely on the stiffness of the sheet material. The spacer elements and their arrangement in a pattern on the air filter sheet material as disclosed herein, thus improves the stiffness of the pleats in a pleat pack, so that also relatively flimsy air filter media can be used as the air filter sheet material of the pleat pack blank, such as for example light synthetic materials or fiberglass material, thus allowing use of a greater range of different air filter materials. Further, the provision of first and second spacer elements, as described above, provides stability, allowing the resulting pleat pack to have greater pleat depth without hindering cleaning performance. Deeper pleats enable a higher amount of filter media per pleat pack.

The second spacer elements arranged on the second side of the air filter sheet material are preferably located in positions that are transversely displaced, i.e. staggered, in relation to the first spacer elements. Thus, the first spacer elements and the second spacer elements are positioned such that the corresponding position on the opposite side of the air filter sheet material is free from any spacer element. In the transverse direction of the air filter sheet material, the spacer elements may suitably be alternatingly a first spacer element and a second spacer element. The first and second spacer elements are preferably arranged such that at least some first spacer elements are positioned between a corresponding pair of second spacer elements, in the transverse direction, and at least some second spacer element are positioned between a corresponding pair of first spacer elements, in the transverse direction. The transversal displacement of the second spacer elements versus the first spacer elements allow for a transversal flexibility of the pleat pack blank so that the pleat density can be varied in the transversal direction, thereby allowing the forming of hollow conical pleat packs or even more complex shapes with transversally varied pleat density. Thereby, each pleat will take up less space than if the spacer element were stacked, which means that the pleat pack can be compressed more and a larger number of pleats can be present in the pleat pack.

Alternatively, the second spacer elements may be arranged on the second side of the sheet material such that second spacer elements are present both at the same transverse positions as the first spacer elements and transversely between adjacent first spacer elements. This alternative may be used to further stabilize the pleats promoting lower pressure drop, but limits geometry to flat or cylindrical pleat packs.

The first spacer elements are suitably positioned along two or more parallel first longitudinal lines, with a distance between two adjacent first longitudinal lines preferably being 0.5-3.0 inches (1.25-7.5 cm), more preferably 1.5-2.5 inches (3.75-6.25 cm). The second spacer elements are likewise suitably positioned along two or more parallel second longitudinal lines, with a distance between two adjacent second longitudinal lines preferably being 0.5-3.0 inches (1.25-7.5 cm), preferably 1.5-2.5 inches (3.75-6.25 cm). Arranging the spacer elements along longitudinal lines facilitates manufacture and stability of the pleat pack. Most preferably, the first and second spacer elements are evenly distributed over the air filter sheet material in a transverse direction thereof, with the second spacer elements displaced to be in the middle between two adjacent first spacer elements. At least some first longitudinal lines may preferably be positioned between a pair of second longitudinal lines in the transverse direction, and at least some second longitudinal lines may preferably be positioned between a pair of first longitudinal lines in the transverse direction.

Preferably, two adjacent second spacer elements may be arranged on each side of, and on a corresponding distance from, a second transversal folding line, such that the two adjacent spacer elements come into contact with each other when the sheet material is folded into a pleat pack. Thereby, the second spacer elements will be at least partly overlapping, which gives the wedge-like channels of the pleat pack an improved V-shape.

The first spacer elements may extend in the longitudinal direction to a length on each side of said first transversal folding line corresponding to 10-95%, preferably 20-85%, of the distance between a first transversal folding line and a second transversal folding line so that the spacer elements come into contact with each other when the sheet material is folded into a pleat pack. Preferably, the total length of the first spacer element should be more than the distance between adjacent first and second transversal folding lines to improve pleat stability. The first spacer elements may thus extend past a mid-pleat line on at least one side of the apex on the first side of the sheet material. Suitably, the first spacer element may extend over the apex with 55-65% of its length on one side of the apex, and 45-55% on the other side of the apex.

The second spacer elements may suitably be substantially shorter than the first spacer elements and may preferably have a length in the longitudinal direction of 10-25% of the longitudinal length of the first spacer elements. Two second spacer elements in a pair of second spacer elements arranged on each side of a second side apex, may have different longitudinal length, so they can form a V-shape without getting too much glue where they meet. If too much glue is present, there is a risk that it can flatten and block off quite a large area of the filter media when it is pleated. Excess glue should therefore preferably be avoided to reduce the risk of blocking of valuable surface area of the filter media, The height of the first and second spacer elements is suitably chosen to fit the intended configuration of the pleat pack. Typically, the height of one spacer element will be approximately half the distance between adjacent apexes on the same side of the pleat pack.

The first and second spacer elements may have a width of approximately 0.01-0.25 inches (0.25-6.4 mm), preferably less than 0.1 inches (2.5 mm), preferably approximately 0.05-0.1 inches (1.3-2.5 mm), to provide sufficient stability to the pleat pack, while leaving as much as possible of the air filter media free to allow proper air filtration properties.

The first and second spacer elements may suitably consist of glue beads, comprised of e.g. thermoset, thermoplastic or elastomer adhesives. The glue beads preferably consist of hotmelt adhesives such as ethylenevinyl acetate (EVA), polyamide etc. Glue beads may for example be applied by means of glue application nozzles, and the pleating may be performed before the glue beads have solidified entirely. Alternatively, the first and second spacer elements may consist of spacer element pieces, made of for example plastic or metallic, that are adhesively attached or simply resting in the air filter sheet material.

As mentioned above, the pleat pack blank is intended to be folded into a pleated zig-zag configuration such that first spacer elements adjacent in the longitudinal direction of the air filter sheet material are in contact with each other. The resulting pleat pack may have the shape of a cuboid or an arch. Two or more cuboid or arch shaped may be joined along their transversal edges. For example, two semi-circular arch shaped pleat pack can be joined into a hollow cylindrical or conical pleat pack, or three or more cuboid pleat pack can be joined into a hollow pyramid pleat pack having e.g. a triangular square or other base shape. Joining two or more pleat pack parts allows for easier to manufacture of the final pleat pack to be installed in a frame. The use of arch or cuboid pleat pack parts allows the parts to be and easier to handle) or say their machine is smaller and only capable of this. Also different medias may be used for the different parts of the final pleat pack if desired.

Alternatively, pleat pack blank may be joined at its transversal edges into a hollow pleat pack, for use for example in a pulse filter application. The first side of the sheet material is then suitably facing inward and the second side of the sheet material facing outward. The hollow pleat pack may have the shape of a cylinder or a cone, and can have circular or elliptical cross sectional shape. Hollow pleat packs having the spacer element pattern disclosed herein have good axial and radial freedom. The above-mentioned hollow cone or pyramid pleat packs may suitably be truncated to facilitate installation and performance.

When mounted in an air filter, the pleat pack is suitably positioned such that said first side of the air filter sheet material is on the downstream side during air filtration.

### Example Embodiments

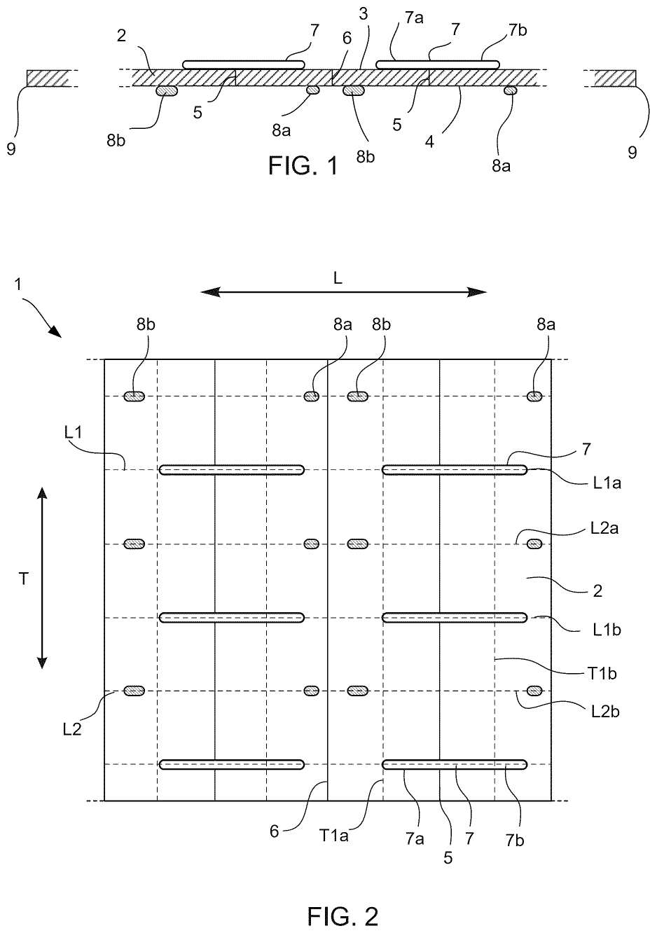

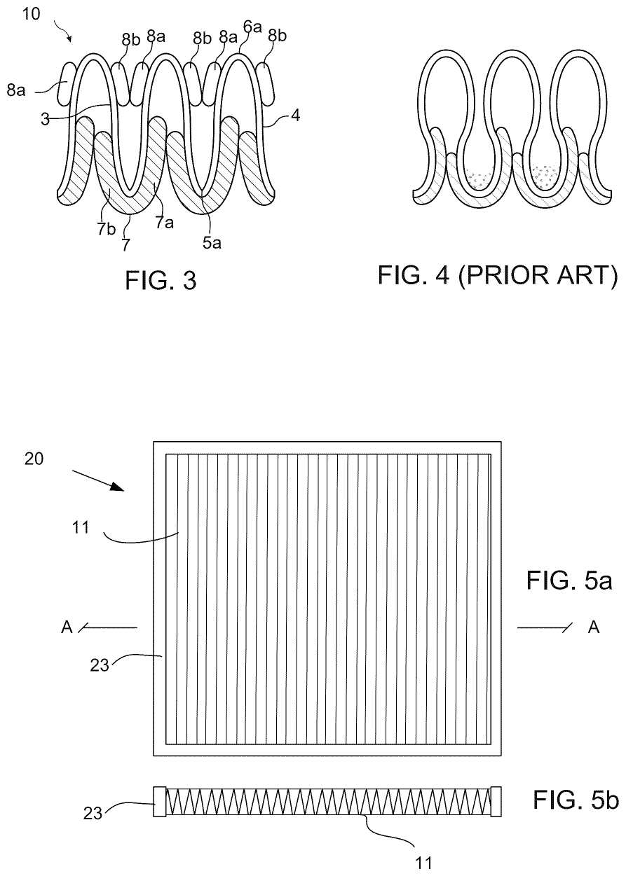

FIGS. 1-2 show cross-sectional and top views of a pleat pack blank 1 according to the present disclosure, and FIG. 2 shows a top view of the same pleat pack blank, i.e. not yet pleated. The pleat pack blank 1 comprises a pleatable air filter sheet material 2, having a first side 3 and a second side 4 opposing each other. A plurality of first transversal folding lines 5 and second transversal folding lines 6 are positioned in a direction T transverse to a longitudinal direction L of the sheet material, such that the sheet material can be folded into a pleated zig-zag configuration. When having been folded into a pleat pack 10, the first transversal folding lines 5 of the pleat pack blank form apexes 5a toward the first side 3 of the sheet material, and the second transversal folding lines 6 form apexes 6a toward the second side 4 of the sheet material, as shown in FIG. 3.

The pleat pack blank further includes a plurality of first spacer elements 7 applied on the first side 3 of the sheet material, and a plurality of second spacer elements 8a,8b applied on the second side 4 of the sheet material, as shown FIGS. 1-3. The spacer elements may preferably consist of glue beads. The first spacer elements 7 is arranged across the first transversal folding line 5/apex 5a and extends in the longitudinal direction of the sheet material along a longitudinal line L1, and each of the second spacer elements 8a,8b is arranged between the second transversal folding line 6/apex 6a and a mid-pleat line T1a, T1b located half-way between two adjacent first and second transversal folding lines 5,6, as shown in FIG. 2. Two adjacent second spacer elements 8a,8b are arranged on each side of the second transversal folding line 6 on a corresponding distance from second transversal folding line. The first spacer elements extend in the longitudinal direction to a length on each side of said first transversal folding line 5 corresponding to 20-85% of the distance between a first transversal folding line 5 and a second transversal folding line 6. As shown, when the blank is formed into a pleat pack, the spacer elements adjacent in the longitudinal direction of the air filter sheet material 2 have been brought into contact with each other. The spacer elements can be bonded or not bonded to each other as desired.

FIG. 2 also illustrates how the second spacer elements 8a,8b arranged on the second side 4 of the air filter sheet material 2 in positions that are transversely displaced in relation to said first spacer elements 7, and that the first spacer elements 7 are positioned along two or more parallel first longitudinal lines L1a, L1b, and the second spacer elements 8a,8b are positioned 2 along two or more parallel second longitudinal lines L2a, L2b. As shown in FIG. 2, the second spacer elements are advantageously positioned in the middle between two first spacer elements in the transverse direction.

FIG. 4 shows a pleat pack according to the prior art.

FIGS. 5 to 8 illustrate examples of air filter including pleat packs made from the pleat pack blank of the present disclosure. FIGS. 5a and 5b illustrate a pleat pack having the shape of a cuboid installed in a frame 23. As shown in the front view of FIG. 5a and the cross-sectional view along the line A-A of FIG. 5b, the frame has a rectangular opening, and the cuboid pleat pack has substantially flat surfaces on the upstream and downstream sides of the filter during air filtration.

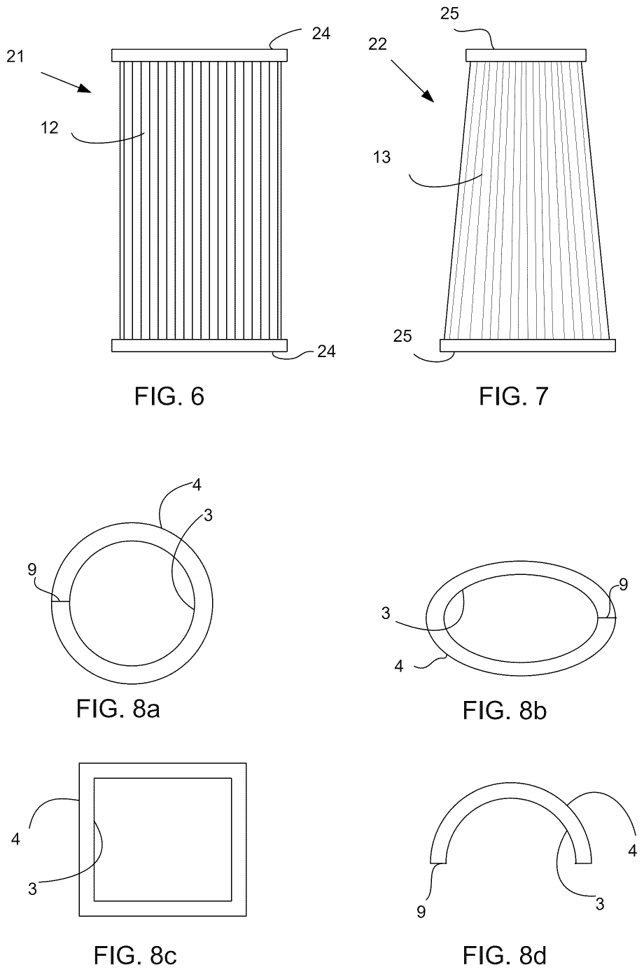

FIGS. 6 and 7 shows examples of pleat packs where the pleat pack blank has been joined at its transversal edges 9 (see FIG. 1) into a hollow pleat pack, with the first side 3 of the sheet material facing inward and the second side 4 of the sheet material facing outward, which has the shape of a cylinder (FIG. 6) or a truncated cone or pyramid (FIG. 7). The hollow pleat packs of FIGS. 6-7 can have a circular or elliptic cross-sectional shape as shown FIGS. 8a, 8b, or a rectangular/square cross-sectional shape as shown FIG. 8c. FIG. 8d illustrates the cross-sectional shape of an arch shaped pleat pack part. In this example, the arch shape is a semi-circle, such that two such pleat pack parts may be joined at the transversal edges 9 into a hollow pleat pack. The pleat pack is suitably positioned in the air filter such that said first side 3 of the air filter sheet material 2 is on the inner side, which is typically downstream side during air filtration.

### Embodiments of the Present Disclosure

Example 1. A pleat pack blank (1) comprising a pleatable air filter sheet material (2) having first (3) and second (4) opposing sides and including a plurality of first and second transversal folding lines (5,6) positioned in a direction (T) transverse to a longitudinal direction (L) of the sheet material, such that the sheet material can be folded into a pleated zig-zag configuration, where each of said first transversal folding lines (5) forms an apex (5a) toward said first side (3) of the sheet material, and each of said second transversal folding lines (6) forms an apex (6a) toward said second side (4) of the sheet material, said pleat pack blank further including a plurality of first spacer elements (7) applied on said first side (3) of the sheet material, and a plurality of second spacer elements (8a,8b) applied on said second side (4) of the sheet material, characterized in that each of said first spacer elements (7) is arranged across the apex (5a) of a first transversal folding line (5) and extends in the longitudinal direction of the sheet material along a longitudinal line (L1), and each of said second spacer elements (8a,8b) is arranged between the apex (6a) of a second transversal folding line (6) and a mid-pleat line (T1a, T1b) located half-way between two adjacent first and second transversal folding lines (5,6).
Example 2. The pleat pack blank of Example 1, wherein said second spacer elements (8a,8b) are arranged on said second side (4) of the air filter sheet material (2) in positions that are transversely displaced in relation to said first spacer elements (7).
Example 3. The pleat pack blank of Example 1 or 2, wherein said first spacer elements (7) are positioned along two or more parallel first longitudinal lines (L1a, L1b).
Example 4. The pleat pack blank of Example 3, wherein the distance between two adjacent first longitudinal lines (L1a, L1b) is 0.5-3.0 inches, preferably 1.5-2.5 inches.
Example 5. The pleat pack blank of any one of Examples 1-4, wherein said second spacer elements (8a,8b) are positioned (2) along two or more parallel second longitudinal lines (L2a, L2b).
Example 6. The pleat pack blank of Example 5, wherein the distance between two adjacent second longitudinal lines (L2a, L2b) is 0.5-3.0 inches, preferably 1.5-2.5 inches.
Example 7. The pleat pack blank of any one of Examples 1-6, wherein two adjacent second spacer elements (8a,8b) are arranged on each side of a second transversal folding line (6) at a corresponding distance from second transversal folding line.
Example 8. The pleat pack blank of any one of Examples 1-7, wherein said first spacer elements extend in the longitudinal direction to a length on each side of said first transversal folding line (5) corresponding to 10-95%, preferably 20-85%, of the distance between a first transversal folding line (5) and a second transversal folding line (6).
Example 9. The pleat pack blank of any one of Examples 1-8, wherein the first and second spacer elements consist of glue beads.
Example 10. An air filter pleat pack (10, 11, 12,13) comprising at least one pleat pack blank according to any one of Examples 1-9, said pleat pack blank having been folded into a pleated zig-zag configuration such that first spacer elements (7) adjacent in the longitudinal direction of the air filter sheet material (2) are in contact with each other.
Example 11. The air filter pleat pack of Example 10, wherein the pleat pack (11) has the shape of a cuboid or an arch.
Example 12. The air filter pleat pack of Example 10, wherein the at least one pleat pack blank has been joined at the transversal edges (9) into a hollow pleat pack (12, 13), with said first side (3) of the sheet material facing inward and said second side (4) of the sheet material facing outward.
Example 13. The air filter pleat pack of Example 12, wherein the hollow pleat pack has the shape of a cylinder (12) or a pyramid or cone (13).
Example 14. An air filter (20, 21, 22) comprising at least one pleat pack of any one of Examples 11-13 joined at the transversal edges (9) into a hollow pleat pack (12, 13) and a pleat pack retaining frame (23) or a pair of pleat pack retaining end plates (24, 25), wherein the pleat pack is positioned in the air filter such that said first side (3) of the air filter sheet material (2) is on the inner side of the cylinder or cone.
Example 15. An air filter (20, 21, 22) comprising the pleat pack of any one of Examples 10-13 and a pleat pack retaining frame (23) or a pair of pleat pack retaining end plates (24, 25), wherein the pleat pack is positioned in the air filter such that said first side (3) of the air filter sheet material (2) is on a downstream side during air filtration.

The person skilled in the art realizes that the present disclosure is not limited to the preferred embodiments described above. The person skilled in the art further realizes that modifications and variations are possible within the scope of the appended claims.

1. A pleat pack blank comprising:
a pleatable air filter sheet material having first and second opposing sides and comprising a plurality of first and second transversal folding lines positioned in a direction (T) transverse to a longitudinal direction (L) of the sheet material, such that the sheet material can be folded into a pleated zig-zag configuration, where each of said first transversal folding lines forms a first apex toward said first side of the sheet material, and each of said second transversal folding lines forms a second apex toward said second side of the sheet material, said pleat pack blank further including a plurality of first spacer elements applied on said first side of the sheet material, and a plurality of second spacer elements applied on said second side of the sheet material, each of said first spacer elements being arranged across the first apex of a first transversal folding line and extends in the longitudinal direction of the sheet material along a longitudinal line, and each of said second spacer elements is arranged between the second apex of a second transversal folding line and a mid-pleat line located half-way between two adjacent first and second transversal folding lines.

2. The pleat pack blank of claim 1, wherein said second spacer elements are arranged on said second side of the air filter sheet material in positions that are transversely displaced in relation to said first spacer elements.

3. The pleat pack blank of claim 1, wherein said first spacer elements are positioned along two or more parallel first longitudinal lines.

4. The pleat pack blank of claim 3, wherein a distance between two adjacent first longitudinal lines is 0.5-3.0 inches, preferably 1.5-2.5 inches.

5. The pleat pack blank of claim 1, wherein said second spacer elements are positioned along two or more parallel second longitudinal lines.

6. The pleat pack blank of claim 5, wherein a distance between two adjacent second longitudinal lines is 0.5-3.0 inches, preferably 1.5-2.5 inches.

7. The pleat pack blank of claim 1, wherein two adjacent second spacer elements are arranged on each side of a second transversal folding line at a corresponding distance from second transversal folding line.

8. The pleat pack blank of claim 1, wherein said first spacer elements extend in the longitudinal direction to a length on each side of said first transversal folding line corresponding to 10-95%, preferably 20-85%, of a distance between a first transversal folding line and a second transversal folding line.

9. The pleat pack blank of claim 1, wherein the first and second spacer elements consist of glue beads.

10. An air filter pleat pack comprising at least one pleat pack blank according to claim 1, wherein said pleat pack blank having been folded into a pleated zig-zag configuration such that first spacer elements adjacent in the longitudinal direction of the air filter sheet material are in contact with each other.

11. The air filter pleat pack of claim 10, wherein the pleat pack has a shape of a cuboid or an arch.

12. The air filter pleat pack of claim 10, wherein the at least one pleat pack blank has been joined at transversal edges into a hollow pleat pack, with said first side of the sheet material facing inward and said second side of the sheet material facing outward.

13. The air filter pleat pack of claim 12, wherein the hollow pleat pack has a shape of a cylinder or a pyramid or cone.

14. An air filter comprising the pleat pack of claim 10 and a pleat pack retaining frame or a pair of pleat pack retaining end plates, wherein the pleat pack is positioned in the air filter such that said first side of the air filter sheet material is on a downstream side during air filtration.

15. The air filter of claim 14, wherein the pleat pack is joined at transversal edges into a hollow cylinder or cone pleat pack and is positioned in the air filter such that said first side of the air filter sheet material is on an inner side of the cylinder or cone.
